(19) United States
(12) Patent Application Publication
(10) Pub. No.: US 2007/0165615 A1
(43) Pub. Date: Jul. 19, 2007

(54) Apparatus and method for notifying communication network event in application server capable of supporting open API based on Web services

(76) Inventors: Young Mee Shin, Daejeon (KR); Sang Ki Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/634,613

(22) Filed: Dec. 6, 2006

(30) Foreign Application Priority Data
Dec. 8, 2005 (KR) 10-2005-0119144
May 9, 2006 (KR) 10-2006-0041493

(51) Int. Cl. H04L 12/66

(52) U.S. Cl. 370/356

(57) ABSTRACT

An apparatus and method for notifying a communication network event in an application server capable of supporting open APIs based on Web services are disclosed. The event notification apparatus configures an event table using a service provisioning manager to perform event notification, and registers static events, allows a service application to request the beginning of dynamic event notification from a gateway. If a corresponding static or dynamic event occurs in the communication network, and the gateway calls an event notification API processor, the event notification API processor transmits the event to the service application by referring to the event table, such that it can notify the service application of the static or dynamic event under the open API environment based on Web services.

### RELATED APPLICATION

The present application is based on, and claims priority from, Korean Application Number 2005-119144, filed Dec. 8, 2005, and Korean Application Number 2006-41493, filed May 9, 2006, the disclosure of which is incorporated by reference herein in its entirety.

### BACKGROUND OF THE INVENTION

1. Field of the Invention

The present invention relates to an apparatus and method for notifying a communication network event in an application server capable of supporting an open API based on Web services.

2. Description of the Related Art

Generally, a method for notifying an event in a system capable of supporting an open API has been disclosed in Korean Patent Laid-open Publication No. 2003-0079544, which is hereby incorporated by reference. A method for notifying an event in a system unconcerned with an open-type system has been disclosed in Korean Patent Laid-open Publication No. 2004-0004362, which is hereby incorporated by reference.

The Korean Patent Laid-open Publication No. 2003-0079544 has disclosed a method for installing a service at an application server capable of processing an open API called a “Parlay”, registering an event, and providing a variety of processes required for informing the system of the event.

However, the technology disclosed in Korean Patent Laid-open Publication No. 2003-0079544 can process only static events (e.g., trigger events) required to be pre-registered before executing a service, and is unable to process dynamic events via which a service application can request notification of interested events during a run-time. Also, the above-mentioned technology disclosed in Korean Patent Laid-open Publication No. 2003-0079544 cannot be applied to an application server capable of supporting an open API based on Web services.

The Korean Patent Laid-open Publication No. 2004-0004362 has disclosed basic event notification mechanism executed by general systems. In more detail, the technology according to the Korean Patent Laid-open Publication No. 2004-0004362 pre-registers not only a map indicating correlation among an event manager (i.e., an event requester), an event notifying user, and a notifying parameter, but also a parameter library. If the event manager receives the event from the event notifying user, the event manager detects an appropriate event requester by referring to the pre-registered map and the parameter library, and notifies the detected event requester of the event. Since the above-mentioned technology uses the map and the parameter library, there is no need to change the event notification method to another method on the condition that only the map and the parameter library are changed to others even if a variety of events are added to a current event, such that the above-mentioned technology according to the Korean Patent Laid-open Publication No. 2004-0004362 can be easily available.

However, the above-mentioned technology according to the Korean Patent Laid-open Publication No. 2004-0004362 cannot be applied to the system capable of supporting the open API based on Web services. In conclusion, the above-mentioned technology according to the Korean Patent Laid-open Publication No. 2004-0004362 is unable to notify the event in the system capable of supporting the open API based on Web services using the event map or the parameter library.

### SUMMARY OF THE INVENTION

Therefore, the present invention has been made in view of the above problems, and it is an object of the present invention to provide an apparatus and method for notifying a communication network event in an application server capable of supporting open APIs based on Web services, thereby supporting notification of static and dynamic events.

It is another object of the present invention to provide an apparatus and method for notifying a communication network event in an application server capable of supporting open APIs based on Web services, which can increase extensibility of a service application using an event table without performing hard-coding routines required for event notification in the service application.

In accordance with one aspect of the present invention, the above and other objects can be accomplished by the provision of an apparatus for notifying a service application of an event received via a gateway using an application server for supporting open APIs (Application Programmer Interface) based on Web services, the apparatus comprising: an event table for storing detailed information associated with a plurality of events; a service provisioning manager for storing the event-associated detailed information in the event table; a service application for requesting beginning or termination of notification of a specific event from a gateway; and an event notification API processor for notifying an event corresponding to the event received via the gateway using the event-associated detailed information stored in the event table.

Preferably, the event table includes a service ID (Identifier), an IP (Internet Protocol) address of service for receiving event, a communication port number of service for receiving event, the number of activated events, and an information field of each event.

Preferably, the event information stored in the event information field includes an event type, a correlation value for determining whether a service-requested event is equal to a event received from the gateway, and reference information associated with the event notification API processor.

Preferably, the service provisioning manager generates a new record (i.e., new record data) in the event table, assigns a service ID (Identifier) to a service application, stores the assigned service ID in a service ID field, stores an IP (Internet Protocol) address of service for event reception in an IP address field, stores a communication port number of service in a communication port number field, stores static event information in a corresponding field, stores the number of the static events in an activated event number field, stores static event types associated with all registered static events in an event type field, stores a reference of the event notification API processor associated with a corresponding event in an reference field of event notification API processor, and stores dynamic event information in a corresponding field.

Preferably, the service provisioning manager, in the case of recording the static event information, records a value of the event type field (also called an event type[i] field) corresponding to a service-interested event as a “true” value which it means that the event is activated, records a value of a correlator field (also called a correlator[i] field) corresponding to the event as a default value, receives a reference value of the event notification API processor corresponding to the event from user, and records a value of reference field (also called an reference[i] field of event notification API processor) as the received reference value.

Preferably, the service provisioning manager, in the case of recording the dynamic event information, receives a reference value of the event notification API processor corresponding to a service-interested event, and records a value of reference field (also called an reference[i] field of event notification API processor) as the received reference value.

Preferably, the service application, in case of requesting the beginning of a dynamic event notification from gateway, searches for record data (i.e., a record) corresponding to its own service ID in the event table, records a value of the event type field(also called an event type[i] field) corresponding to a desired event as a “true” value which it means that the event is activated, generates a correlation value, and records a value of a correlator field (also called a correlator[i] field) corresponding to the desired event contained in the record data as the generated correlation value. Preferably, the service application extracts a value of a reference field (also called a reference[i] field of the event notification API processor) corresponding to the desired event from the record data, increases an activated event number field value of the record data by a specific number “1”, calls the gateway using the extracted event notification API processor's reference and the generated correlation value as input parameters.

Preferably, the service application, in case of requesting termination of a dynamic event notification from the gateway, searches for record data (i.e., a record) corresponding to its own service ID in the event table, changes a value of the event type field(also called an event type[i] field) corresponding to a desired event to a “false” value which it means that the event is terminated, extracts a value of a correlator field (also called a correlator[i] field) corresponding to the desired event contained in the record data, and changes the value of the correlator field value to a default value. Preferably, the service application reduces an activated event number field value of the record data by a specific number “1”, calls the gateway using the extracted correlation value as an input parameter.

Preferably, the event notification API processor, upon being called from the gateway, searches for record data (i.e., a record) corresponding to its own service ID in the event table; extracts a value of an event type field (also called an event type[i] field) corresponding to the event received from the gateway; determines whether the extracted value is indicative of a “true” value; extracts a value of a correlator field (also called a correlator[i] field) corresponding to the event received from the gateway when the extracted value is indicative of the “true” value; and extracts an IP address of service for event reception and a communication port from record data (i.e., a record) when the extracted value is indicative of a default value, and notifies the service application of the event using the extracted IP address and the communication port.

Preferably, the event notification API processor, if the extracted correlation value is not determined to be the default value, compares the extracted correlation value with the correlation value received from the gateway as the parameter, extracts the IP address of service for receiving the event and the communication port from the record when the extracted correlation value is equal to the correlation value received from the gateway, and notifies the service application of the event using the extracted IP address and the communication port.

Preferably, the service application, the event notification API processor, and the service provisioning manager support a “Parlay X API” standardized by a “Parlay/OSA” group.

In accordance with another aspect of the present invention, there is provided a method for notifying a service application of an event received via a gateway using an application server for supporting open APIs (Application Programmer Interface) based on Web services, the method comprising the steps of: a) storing detailed information associated with the event to notify the service application of the event; and b) requesting beginning of notification of a dynamic event from the gateway, notifying an event corresponding to the event received via the gateway using the event-associated detailed information stored in the event table, and requesting termination of the notification of a dynamic event from the gateway.

Preferably, the storing step a) includes the steps of: a1) generating a new record (i.e., new record data) in the event table, and performing initialization of the new record; a2) assigning a service ID (Identifier) to a service application, and recording the assigned service ID in the generated new record; a3) receiving an IP (Internet Protocol) address of service for event reception and a communication port number from user, and recording the received IP address and the communication port number in the record; a4) receiving static event information from user, and recording the static event information in the record; a5) recording the number of the static events as an activated event number field value; a6) registering static event types of all the registered static events and event notification references associated with each corresponding event in the gateway; and a7) receiving dynamic event information from user, and recording the received dynamic event information in the record.

Preferably, the step a4) includes the steps of: a4-1) recording a value of an event type field (also called an event type[i] field) corresponding to a service-interested event as a “true” value which it means that the event is active; a4-2) recording a value of a correlator field (also called a correlator[i] field) corresponding to the event as a default value; and a4-3) receiving a reference value of the event notification API processor corresponding to the event from user, and recording a value. of a reference field (also called an reference[i] field of event notification API processor) as the received reference value.

Preferably, the step a7) includes the steps of: a7-1) receiving a reference value of the event notification API processor corresponding to a service-interested event from user; and a7-2) recording a value of the reference field (also called an reference[i] field of event notification API processor) as the received reference value.

Preferably, the step b) for requesting the beginning of a dynamic event notification from the gateway includes the steps of: b1) searching for record data (i.e., a record) corresponding to its own service ID in the event table; b2) recording a value of the event type field(also called an event type[i] field) corresponding to a desired event as a “true” value, and generating a correlation value; b3) recording a value of a correlator field (also called a correlator[i] field) corresponding to the desired event from the record data as the generated correlation value; b4) extracting a value of a reference field (also called a reference[i] field of the event notification API processor) corresponding to the desired event from the record data; b5) increasing an activated event number field value of the record data by a specific number “1”; and b6) calling the gateway using the extracted event notification API processor's reference and the generated correlation value as input parameters, and requesting the beginning of the specific event notification from the gateway.

Preferably, the step b) for requesting the termination of a dynamic event notification from the gateway includes the steps of: b7) searching for record data (i.e., a record) corresponding to its own service ID in the event table; b8) changing a value of the event type field corresponding to a desired event to a “false” value, b9)extracting a value of a correlator field (also called a correlator[i] field) corresponding to a desired event contained in the record data, and changing a value of the correlator field to a default value; and b10) reducing an activated event number field value of the record data by a specific number “1”, b11) calling the gateway using the extracted correlation value as an input parameter, and requesting termination of event notification from the gateway.

Preferably, the step b) for notifying an event corresponding to the event received via the gateway using the event-associated detailed information stored in the event table includes the steps of: b12) upon being called from the gateway, searching for record data (i.e., a record) corresponding to its own service ID in the event table; b13) extracting a value of an event type field (also called an event type[i] field) corresponding to the event received from the gateway; b14) determining whether the extracted value is indicative of a “true” value, and extracting a value of a correlator field (also called a correlator[i] field) corresponding to the event received from the gateway when the extracted value is indicative of the “true” value; and b15) extracting an IP address of service for event reception and a communication port from the record data (i.e., a record) when the extracted value is indicative of a default value, and notifying the service application of the event using the extracted IP address and the communication port.

Preferably, the method further comprises the steps of: if the extracted correlation value is not determined to be the default value, comparing the extracted correlation value with the correlation value received from the gateway as the parameter; and if the extracted correlation value is equal to the correlation value received from the gateway, extracting the IP address of service for receiving the event and the communication port from the record, and notifying the service application of the event using the extracted IP address and the communication port.

Preferably, the service application, the event notification IP processor, and the service provisioning manager support a “Parlay X API” standardized by a “Parlay/OSA” group.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating an apparatus for notifying a communication network event in an application server capable of supporting open APIs based on Web services, and a network structure of the application server according to the present invention;

FIG. 2 is a structural diagram illustrating an event table shown in FIG. 1 according to the present invention;

FIG. 3 is a flow chart illustrating a service provisioning method performed by a service provisioning manager in an event notification apparatus according to the present invention;

FIG. 4 is a flow chart illustrating a method for requesting dynamic event notification for a service application in an event notification apparatus according to the present invention;

FIG. 5 is a flow chart illustrating an event notification method of an API processor for event notification in an event notification apparatus according to the present invention; and

FIG. 6 is a flow chart illustrating a method for requesting dynamic event notification termination for a service application in an event notification apparatus according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

An apparatus and method for notifying a communication network event in an application server capable of supporting open APIs based on Web services will hereinafter be described with reference to the annexed drawings.

The open API based on Web services is indicative of a “Parlay X API” which is being standardized by a standard group called “OSA/Parlay”.

There are a variety of systems for supporting the above-mentioned Parlay X API, for example, an application server (AS), a gateway, a communication network, and a terminal, etc.

The application server provides the principal environment for executing the service application.

The service application composed by a service programmer is deployed in the application server, and is then executed by the application server.

The gateway acts as Middleware between the application server and the communication network. The communication network is indicative of a general wired- or wireless-communication network. The terminal is indicative of a general communication network.

There are a variety of Parlay X API, for example, a first API for allowing the service application to request a communication network access from the gateway, a second API for allowing the service application to request the beginning or termination of event notification from the gateway, and a third API for allowing a gateway to notify a communication network event. The first and second APIs are implemented in the gateway, and the third API is implemented in the service application side.

The service application for use in open APIs based on Web services requires two event notification. The first event notification is a notification associated with a static event to be pre-registered prior to the execution of the service application. The second event notification is a notification associated with a dynamic event for requesting event notification from the service application during the run-time, and requesting termination of the event notification from the service application.

The service application for using open APIs based on Web services includes the following three elements. Firstly, the service application includes a main logic unit for a service, and the main logic unit includes the principal logics to be ultimately executed by the service. Secondly, the service application requires Web service client codes for calling open APIs of a gateway. Thirdly, the service application requires Web services for implementing APIs capable of receiving communication network event from the gateway.

The above-mentioned first and second elements are generally implemented with a single program, and the above-mentioned third element is implemented with a Web service server. However, the above-mentioned first, second, and third elements logically configure a single service application.

In order to execute the service application in the application server, the service application requires a provisioning procedure associated with the service.

The above-mentioned provisioning procedure must provide the application server with a variety of information must be provided to the application server in association with the event processing, and a detailed description thereof will hereinafter be described in detail.

Firstly, the provisioning procedure must assign a unique service ID to a service application and provide the application server with categories of service-interested static events, an IP address of service for event reception, a communication network port number, and references (e.g., URLs) of Web-service servers for implementing open APIs for event notification in association with each static event.

The application server informs the gateway of the static event categories and the references of the Web-service server for implementing the open APIs for event notification, and registers static events associated with a corresponding service in the application server.

In order to finally transmit the events to the service, the static events are registered in the application server and the gateway using a service provisioning procedure. The service provisioning procedure provides a user with a user's account, an account access authority, an account-associated authority, and account management resources.

Indeed, if a corresponding event occurs in a communication network, the gateway extracts reference of the Web-service server for implementing the event notification API, and calls an event notification operation of the Web-service server of the extracted reference.

The called Web-service server extracts an event reception IP address of the service registered in the above-mentioned provisioning procedure and a communication network port number of the service, and transmits events using the IP address and the communication port number.

If required, the service application may request the beginning or termination of dynamic event notification during the run-time.

If the service application requests the beginning of a specific event notification from the gateway, the service application must transfer a reference of the Web-service server having implemented the open API for event notification and a newly-created correlation value to the gateway.

The above-mentioned correlation value is adapted to determine whether the event requested by the service is equal to the event notified by the gateway. If a corresponding event occurs, the gateway extracts the reference of the Web-service server for implementing the event-notification open API received from the service, calls the event-notification operation of the Web-service server of the extracted reference, and at the same time transmits a correlation value as a parameter.

In order to finally transmit the events to the service, the called Web-service server extracts an event reception IP address of the service registered in the provisioning procedure and a communication network port number of the service, and transmits events using the IP address and the communication port number.

An apparatus and method for notifying a communication network event in an application server capable of supporting open APIs based on Web services according to the present invention will hereinafter be described with reference to the annexed drawings.

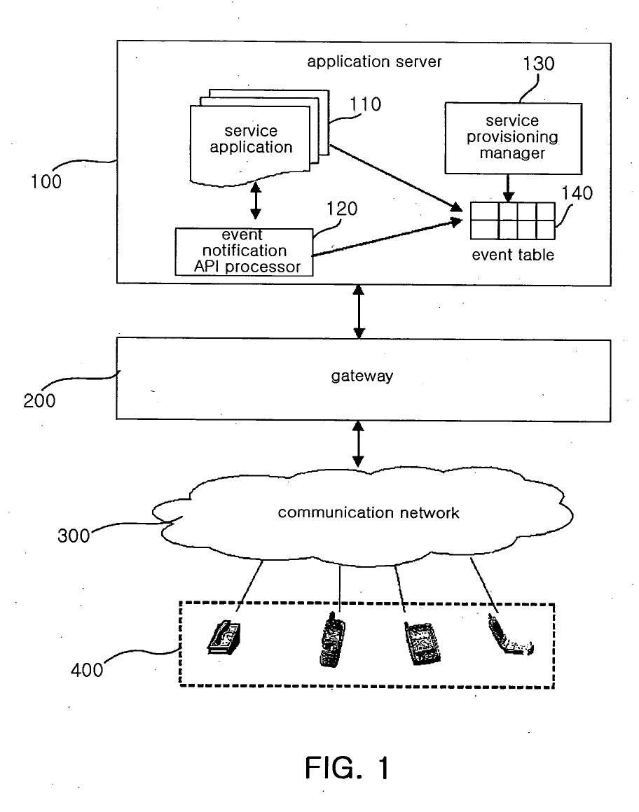

FIG. 1 is a block diagram illustrating an apparatus for notifying a communication network event in an application server capable of supporting open APIs based on Web services, and a network structure of the application server according to the present invention.

Referring to FIG. 1, a network structure for an event processing system according to the present invention includes an application server 100, a gateway 200, a communication network 300, and a plurality of user terminals 400.

The application server 100 may include the service application 110, the event notification API processor 120, the service provisioning manager 130, and an event table 140.

The service application 110 composed by the service programmer is contained (or deployed) in the application server 100, and is then executed by the application server 100.

In order to receive a communication network event from the gateway 200 from among open APIs based on Web services, the event-notification API processor 120 includes a process function associated with the event notification API to be implemented in the service application side, and is implemented with a Web service server.

The service provisioning manager 130 acquires necessary data by providing the service provisioning procedure, and stores/manages the acquired data in the event table 140.

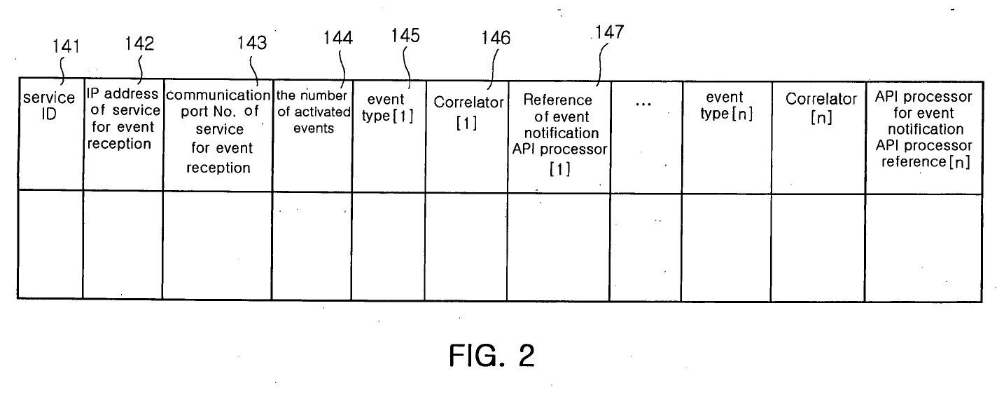

The event table 140 stores a variety of information required to inform all services contained in the application server 100 of the communication network event. In this case, the event table 140 shown in FIG. 1 will hereinafter be described with reference to FIG. 2.

FIG. 2 is a structural diagram illustrating an event table shown in FIG. 1 according to the present invention.

Referring to FIG. 2, the event table 140 includes a service ID field 141, an IP address field 142 of service for receiving event, a communication port number field 143 of service for receiving event, an activated event number field 144, an event type field 145, a correlator field 146, and an reference field 147 of event notification API processor.

The event type field 145, the correlator field 146, and reference field 147 of the event notification API processor may be composed of a plurality of elements. In other words, one or more event type fields 145, one or more correlator fields 146, and one or more event notification API processor reference fields 147 may exist.

The service ID information contained in the service ID field 141 indicates a service ID, and is used as a primary key in the event table 140.

The IP address field 142 of service for event reception indicates an IP address required for a communication unit capable of allowing the event notification API processor 120 to notify the service of the event. The communication port number field 143 indicates a communication port number capable of allowing the event notification API processor 120 to notify the service of the event.

The activated event number field 144 indicates the number of events currently desired by a corresponding service, and is equal to the sum of the number of static events and the number of dynamic events.

The event type[i] field 145 indicates whether an i-th event is activated by a current service using a “true” value or a “false” value. In this case, each event corresponds to event type[i] contained in a predetermined range [1 . . . n].

In more detail, provided that an i-th event corresponds to a predetermined static event, and indicates a service registered as a static event by the provisioning procedure, the event type[i] field 145 has the “true” value. Otherwise, if the i-th event does not indicate the service registered as a static event by the provisioning procedure, the event type[i] field 145 has the “false” value.

Provided that the i-th event corresponds to a predetermined dynamic event, and the service application requests notification of a corresponding event from the gateway 200 during the run-time, the event type[i] field 145 has the “true” value. Otherwise, if the service application does not request the notification of the corresponding event from the gateway 200 during the run-time, the event type[i] field 145 has the “false” value.

Upon receiving the i-th event from the gateway 200, the correlator[i] field 146 is adapted to record a correlation value for determining whether the received i-th event is requested by the service.

The correlation value recorded in the correlator[i] field is not assigned to the static event(e.g., zero “0”). However, in association with dynamic events, the service application 110 generates a correlation value when requesting notification of the dynamic event notification from the gateway 200, such that it transmits the correlation value acting as a parameter to the gateway 200.

In this case, the service application 110 records the correlation value in the correlator[i] field before transmitting the parameter value to the gateway 200.

If the service application 110 requests termination of a dynamic event notification from the gateway 200, the correlator[i] value is initialized to zero “0”.

In the meantime, reference[i] field 147 of the event notification API processor indicates a reference (e.g., a URL) of a Web-service server called by the gateway 200 from among open APIs based on Web services. In this case, as previously stated above, the Web-service server implements the API for receiving event notification in association with the i-th event.

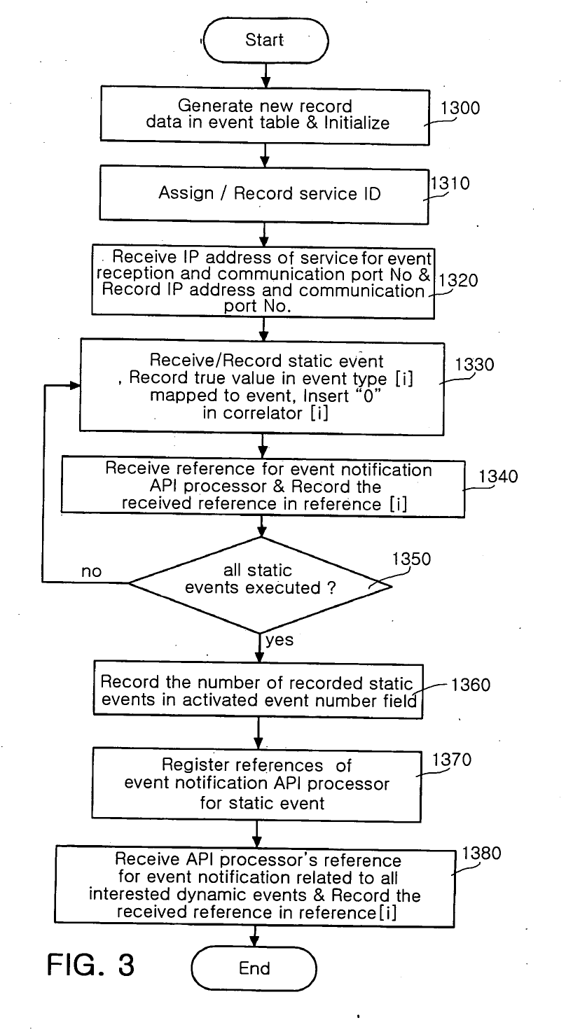

Operations of the service provisioning procedure supplied from the service provisioning manager 130 shown in FIG. 1 will hereinafter be sequentially described in detail with reference to FIG. 3.

FIG. 3 is a flow chart illustrating the service provisioning procedure performed by a service provisioning manager 130 according to the present invention.

The service provisioning manager 130 generates a new record data (also called a new record) to be added to the event table 140, and performs initialization of the new record data at step 1300. During the initialization, the event type[i] field value is set to a “false” value at step 1300.

After performing the initialization, the service provisioning manager 130 assigns a service ID, and records the assigned value as a value of a service ID field of the record data at step 1310.

The service provisioning manager 130 receives an IP address of service for receiving event and a port number from user, and records the IP address and the port number in a corresponding field of the record data at step 1320.

The service provisioning manager 130 receives static event category information from user, sets a value of the event type [i] field corresponding to the received event to a “true” value, and sets a value of the correlator[i] field to a default value “0” at step 1330.

The service provisioning manager 130 receives a reference of the event notification API processor associated with the static event from user, and records the received reference in the reference[i] field at step 1340.

Thereafter, the service provisioning manager 130 determines whether all the static event information is collected at step 1350. If it is determined that all the static event information is collected at step 1350, the service provisioning manager 130 records data indicating the number of the static events as the activated event number field value in the record at step 1360.

The service provisioning manager 130 registers the references of the event notification API processor corresponding to the interested static events in the gateway 200 at step 1370.

If the static event registration is completed, the service provisioning manager 130 collects dynamic event information. The service provisioning manager 130 receives the references of the event notification API processor associated with all the interested dynamic events from user, and records the received reference in a corresponding reference[i] field at step 1380.

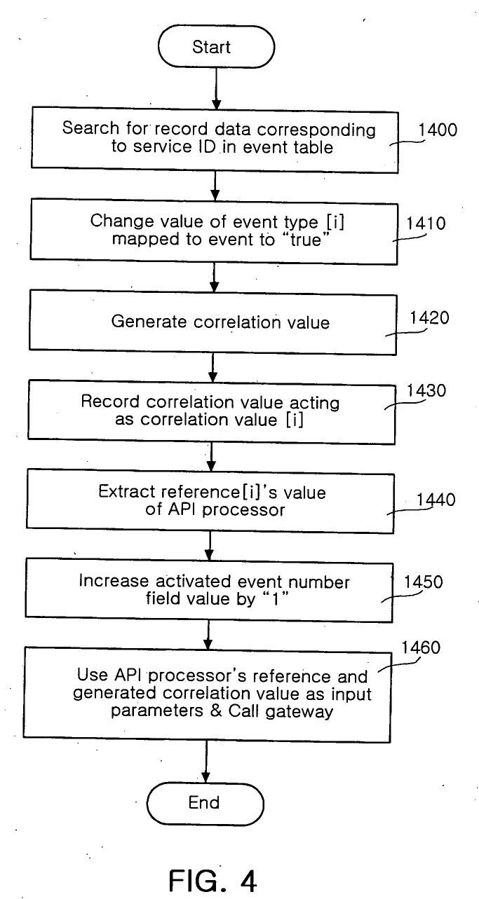

As described above, if the service provisioning manager 130 completes the service provisioning procedure, it requests notification of dynamic events generated from the service application 110 from the gateway 200, and a detailed description thereof will hereinafter be described with reference to FIG. 4.

FIG. 4 is a flow chart illustrating a method for requesting a dynamic event notification for the service application 110 from the gateway 200 according to the present invention.

Firstly, the service application 110 searches for record data (i.e., a record) corresponding to its own service ID in the service ID field 141 of the event table 140 at step 1400.

The service application 110 changes an event type value of the event type[i] field 145 corresponding to an interested event from among the record to a “true” value at step 1410.

The service application 110 generates a correlation value at step 1420. The service application 110 records the above-mentioned correlation value in a corresponding field (i.e., correlator[i] field 146) of the event table 140 as a specific correlation value having generated the correlator[i] field value at step 1430.

The service application 110 extracts the reference value of the event notification API processor from the reference[i] field 147 of the event notification API processor at step 1440.

The service application 110 increases the value of the activated event number field 144 by a specific number “1” at step 1450, resulting in the creation of “activated event number field 144's value +1”.

The service application 110 calls the gateway 200 using the extracted event notification API processor's reference value and the generated correlation value as input parameters at step 1460.

As described above, if the service application 110 requests the beginning of notification of dynamic events from the gateway 200, and the event notification API processor 120 is called by the gateway 200, the event notification API processor 120 notifies the service application 110 of the received event.

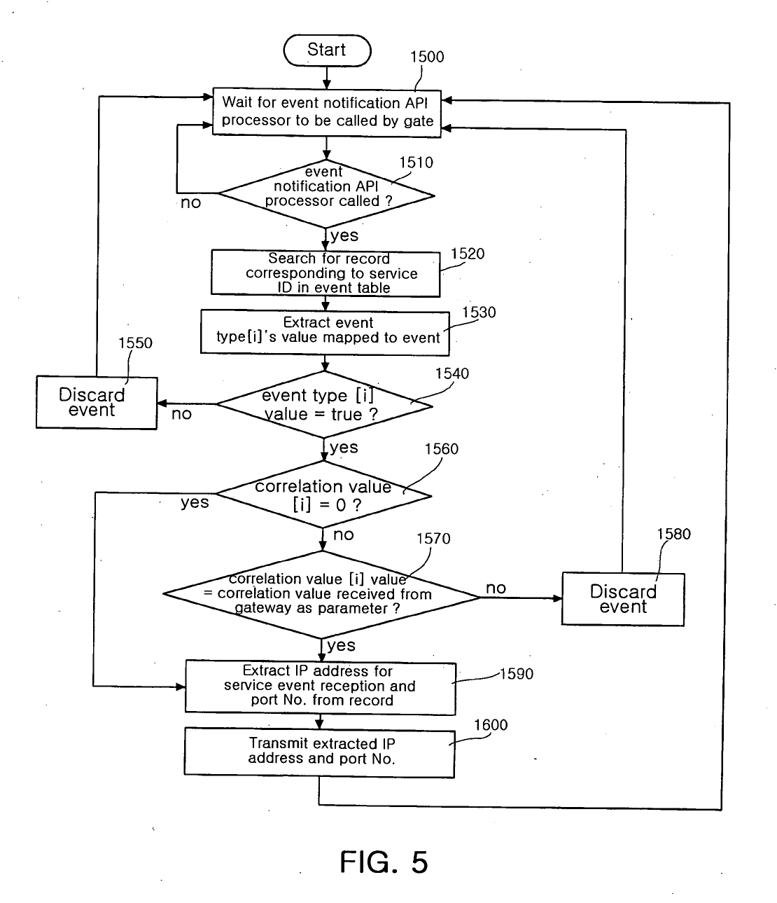

An event notification method according to the present invention will hereinafter be sequentially described with reference to FIG. 5.

FIG. 5 is a flow chart illustrating an event notification method of the event notification API processor for use in an event processing system (i.e., an event notification apparatus) according to the present invention.

Referring to FIG. 5, the event notification API processor 120 associated with static or dynamic events of the application server 100 enters a standby mode to be called by the gateway 200 at step 1500, and determines whether the calling is generated from the gateway 200 at step 1510.

If it is determined that the calling has been generated from the gateway 200 at step 1510, the event notification API processor 120 searches for record data (i.e., record) corresponding to its own service ID in the service ID field 141 of the event table 140 at step 1520.

The event notification API processor 120 extracts an event type[i] field value corresponding to the event, received from the gateway 200, from the record data at step 1530.

Thereafter, the event notification API processor 120 determines whether the extracted event type value is a “true” value at step 1540.

If the extracted event type value is not determined to be the “true” value at step 1540, the event notification API processor 120 discards the corresponding event, and returns to the standby mode waiting for being called by the gateway 200 at step 1550.

Otherwise, if the event type value stored in the event type field 145 of the event table 140 is determined to be the “true” value at step 1540, the event notification API processor 120 determines whether the correlator[i] field value of the event table 140 is a default value “0” at step 1560.

If it is determined that whether the correlator[i] field value of the event table 140 is equal to the default value “0” at step 1560, this means that a current event is a static event, such that the event notification API processor 120 extracts the IP address of service for event reception and the communication port number from the event table 140 at step 1590, and performs event notification using the extracted IP address and the port number at step 1600.

Otherwise, if it is determined that whether the correlator[i] field value of the event table 140 is not determined to be the default value “0” at step 1560, the event notification API processor 120 determines whether the correlator[i] field value of the event table 140 is equal to a correlation value received from the gateway 200 as a parameter at step 1570.

If the correlator[i] field value recorded in the event table 140 is equal to the above-mentioned correlation value received from the gateway 200 as the parameter, the event notification API processor extracts the IP address and the communication port number from the event table 140 at step 1590, and transmits the corresponding event to the service at step 1600.

In the meantime, if the correlator[i] field value recorded in the event table 140 is not equal to the correlation value received from the gateway 200 as the parameter at step 1570, the event notification API processor 120 discards the corresponding event, and returns to the standby mode at step 1580.

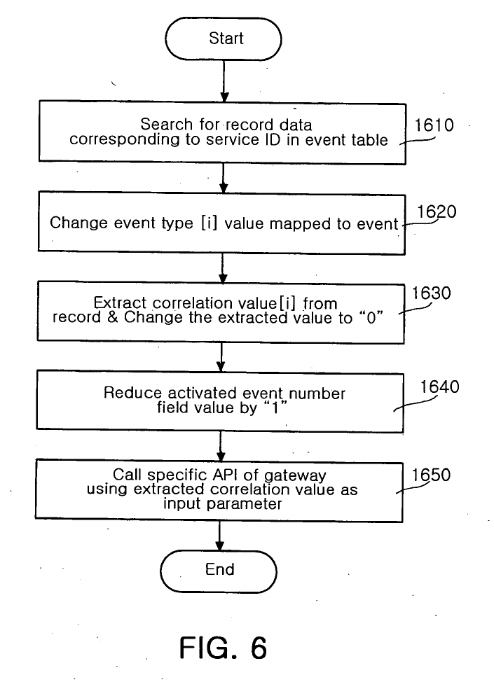

In this way, the service application 110 requests termination of a dynamic event notification from the gateway 200, and a detailed description thereof will hereinafter be described with reference to FIG. 6.

FIG. 6 is a flow chart illustrating a method for requesting termination of a dynamic event notification from the gateway 200 in the event processing system (i.e., the event notification apparatus) according to the present invention.

Referring to FIG. 6, the service application 110 searches for record data (i.e., record) corresponding to its own service ID in the service ID field 141 of the event table 140 at step 1610.

The service application 110 changes the value of the event type[i] field 145 corresponding to an interested event from the record of the above-mentioned retrieved service ID to a “false” value at step 1620.

The service application 110 extracts the value of the correlator[i] field 146, and performs initialization of the correlator[i] field's value at step 1630, such that the correlator[i] field's value is set to the default value “0” at step 1630.

The service application 110 reduces the value of the activated event number field 144 by a specific number “1” at step 1640, resulting in the creation of “activated event number field 144's value −1”.

In this way, the service application 110 calls the gateway 200 using the extracted correlation value, such that the above-mentioned event notification process is terminated at step 1650.

As apparent from the above description, the apparatus and method for notifying a communication network event in an application server capable of supporting open APIs based on Web services according to the present invention can support notification of static and dynamic events, and can increase extensibility of a service application using an event table without performing hard-coding routines required for event notification in the service application.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for notifying a service application of an event received via a gateway in an application server for supporting open APIs (Application Programmer Interface) based on Web services, the apparatus comprising:
an event table for storing detailed information associated with a plurality of events;
a service provisioning manager for storing the event-associated detailed information in the event table;
a service application for requesting beginning or termination of notification of a specific event from a gateway; and
an event notification API processor for notifying an event corresponding to the event received via the gateway using the event-associated detailed information stored in the event table.

2. The apparatus according to claim 1, wherein the event table includes a service ID (Identifier), an IP (Internet Protocol) address of service for event reception, a communication port number of service for event reception, the number of activated events, and an information field of each event.

3. The apparatus according to claim 2, wherein the event information stored in the event information field includes an event type, a correlation value for determining whether a service-requested event is equal to another event received from the gateway, and reference information associated with the event notification API processor.

4. The apparatus according to claim 1, wherein:
the service provisioning manager generates a new record (i.e., new record data) in the event table, assigns a service ID (Identifier) to a service application, stores the assigned service ID in a service ID field, stores an IP (Internet Protocol) address of service for event reception in an IP address field, stores a communication port number in a communication port number field, stores static event information indicating the number of static events in a corresponding field, stores an activated event number field value associated with the number of the static events in an activated event number field, stores static event types associated with all registered static events in an event type field, stores a reference of the event notification API processor associated with a corresponding event in a reference field of event notification API processor, and stores dynamic event information indicating the number of dynamic events in a corresponding field.

5. The apparatus according to claim 4, wherein the service provisioning manager, in the case of recording the static event information, records a value of the event type field (also called an event type[i] field) corresponding to an interested event as a “true” value, records a value of a correlator field (also called a correlator[i] field) corresponding to the event as a default value, receives a reference value of the event notification API processor corresponding to the event from user, and records a value of the event notification API processor reference field (also called a reference[i] field of event notification API processor) as the received reference value.

6. The apparatus according to claim 4, wherein the service provisioning manager, in the case of recording the dynamic event information, receives a reference value of the event notification API processor corresponding to an interested event from user, and records a value of the event notification API processor reference field (also called a reference[i] field of event notification API processor) as the received reference value.

7. The apparatus according to claim 1, wherein:
the service application searches for record data (i.e., a record) corresponding to its own service ID in the event table, records a value of the event type field corresponding to a desired event as a “true” value, generates a correlation value, and records a value of a correlator field (also called a correlator[i] field) corresponding to the desired event contained in the record data as the generated correlation value, and
the service application extracts a value of a reference field (also called a reference[i] field) of the event notification API processor corresponding to the desired event from the record data, increases an activated event number field value of the record data by a specific number “1”, calls the gateway using the extracted event notification API processor's reference and the generated correlation value as input parameters, and requests the beginning of event notification from the gateway.

8. The apparatus according to claim 1, wherein:
the service application searches for record data (i.e., a record) corresponding to its own service ID in the event table, changes a value of the event type field corresponding to a desired event to a “false” value, extracts a value of a correlator field (also called a correlator[i] field) corresponding to the event contained in the record data, and changes a value of the correlator field value to a default value, and
the service application reduces an activated event number field value of the record data by a specific number “1”, calls the gateway using the extracted correlation value as an input parameter, and requests termination of event notification from the gateway.

9. The apparatus according to claim 1, wherein:
the event notification API processor, upon being called from the gateway, searches for record data (i.e., a record) corresponding to its own service ID in the event table; extracts a value of an event type field (also called an event type[i] field) corresponding to the event received from the gateway; determines whether the extracted value is indicative of a “true” value; extracts a value of a correlator field (also called a correlator[i] field) corresponding to the event received from the gateway when the extracted value is indicative of the “true” value; and extracts an IP address of service for event reception and a communication port from the record data (i.e., a record) when the extracted value is indicative of a default value, and notifies the service application of the event using the extracted IP address and the communication port.

10. The apparatus according to claim 9, wherein the event notification API processor, if the extracted correlation value is not determined to be the default value, compares the extracted correlation value with the correlation value received from the gateway as the parameter, extracts the IP address of service for receiving event and the communication port from the record when the extracted correlation value is equal to the correlation value received from the gateway, and notifies the service application of the event using the extracted IP address and the communication port.

11. The apparatus according to claim 1, wherein the service application, the event notification API processor, and the service provisioning manager support a “Parlay X API” standardized by a “Parlay/OSA” group.

12. A method for notifying a service application of an event received via a gateway using an application server for supporting open APIs (Application Programmer Interface) based on Web services, the method comprising the steps of:
a) storing detailed information associated with the event to notify the service application of the event; and
b) requesting beginning of notification of a specific event from the gateway, notifying an event corresponding to the event received via the gateway using the event-associated detailed information stored in the event table, and requesting termination of the notification of the specific event from the gateway.

13. The method according to claim 12, wherein the event table includes a service ID (Identifier), an IP (Internet Protocol) address of service for receiving event, a communication port number of service for receiving event, the number of activated events, and an information field of each event.

14. The method according to claim 13, wherein the event information stored in the event information field includes an event type, a correlation value for determining whether a service-requested event is equal to another event received from the gateway, and reference information associated with the event notification API processor.

15. The method according to claim 12, wherein the storing step a) includes the steps of:
a1) generating a new record (i.e., new record data) in the event table, and performing initialization of the new record;
a2) assigning a service ID (Identifier) to a service application, and recording the assigned service ID in the generated new record;
a3) receiving an IP (Internet Protocol) address of service for event reception and a communication port number, and recording the received IP address and the communication port number in the record;
a4) receiving static event information indicating the number of static events, and recording the static event information in the record;
a5) recording the number of the static events as an activated event number field value;
a6) registering static event types of all the registered static events and references of event notification API processor associated with a corresponding event in the gateway; and
a7) receiving dynamic event information indicating the number of service-interested dynamic events, and recording the received dynamic event information in the record.

16. The method according to claim 15, wherein the step a4) includes the steps of:
a4-1) recording a value of an event type field (also called an event type[i] field) corresponding to an interested event as a “true” value;
a4-2) recording a value of a correlator field (also called a correlator[i] field) corresponding to the event as a default value; and
a4-3) receiving a reference value of the event notification API processor corresponding to the event, and recording a value of reference field (also called a reference[i] field of event notification API processor) as the received reference value.

17. The method according to claim 15, wherein the step a7) includes the steps of:
a7-1) receiving a reference value of the event notification API processor corresponding to an interested event; and
a7-2) recording a value of reference field (also called a reference[i] field of event notification API processor) as the received reference value.

18. The method according to claim 12, wherein the step b) for requesting the beginning of the specific event notification from the gateway includes the steps of:
b1) searching for record data (i.e., a record) corresponding to its own service ID in the event table;
b2) recording a value of the event type field corresponding to a desired event as a “true” value, and generating a correlation value;
b3) recording a value of a correlator field (also called a correlator[i] field) corresponding to the desired event contained in the record data as the generated correlation value;
b4) extracting a value of a reference field (also called a reference[i] field of the event notification API processor) corresponding to the desired event from the record data;
b5) increasing an activated event number field value of the record data by a specific number “1”; and
b6) calling the gateway using the extracted event notification API processor's reference and the generated correlation value as input parameters, and requesting the beginning of the specific event notification from the gateway.

19. The method according to claim 12, wherein the step b) for requesting the termination of the specific event notification from the gateway includes the steps of:
b7) searching for record data (i.e., a record) corresponding to its own service ID in the event table;
b8) changing a value of the event type field corresponding to a desired event to a “false” value;
b9) extracting a value of a correlator field (also called a correlator[i] field) corresponding to the desired event contained in the record data, and changing a value of the correlator field to a default value;
b10) reducing an activated event number field value of the record data by a specific number “1”; and
b11) calling the gateway using the extracted correlation value as an input parameter, and requesting termination of event notification from the gateway.

20. The method according to claim 12, wherein the step b) for requesting the beginning of notification of the specific event from the gateway, and notifying an event corresponding to the event received via the gateway using the event-associated detailed information stored in the event table includes the steps of:
b12) upon being called from the gateway, searching for record data (i.e., a record) corresponding to its own service ID in the event table;
b13) extracting a value of an event type field (also called an event type[i] field) corresponding to the event received from the gateway;
b14) determining whether the extracted value is indicative of a “true” value, and extracting a value of a correlator field (also called a correlator[i] field) corresponding to the event received from the gateway when the extracted value is indicative of the “true” value; and
b15) extracting an IP address of service for event reception and a communication port from the record data (i.e., a record) when the extracted value is indicative of a default value, and notifying the service application of the event using the extracted IP address and the communication port.

21. The method according to claim 20, further comprising the steps of:
if the extracted correlation value is not determined to be the default value, comparing the extracted correlation value with the correlation value received from the gateway as the parameter; and
if the extracted correlation value is equal to the correlation value received from the gateway, extracting the IP address of service for receiving event and the communication port from the record, and notifying the service application of the event using the extracted IP address and the communication port.
